(19) United States
(12) Patent Application Publication
(10) Pub. No.: US 2019/0266649 A1
(43) Pub. Date: Aug. 29, 2019

(54) System and Method for Facilitating a Fractional Share Purchase

(71) Applicants: Aaron Everett Holland, Los Angeles, CA (US); Jonathan Mark Rappaport, Encinitas, CA (US)

(72) Inventors: Aaron Everett Holland, Los Angeles, CA (US); Jonathan Mark Rappaport, Encinitas, CA (US)

(73) Assignee: Season Share Inc., Los Angeles, CA (US)

(21) Appl. No.: 15/678,940

(22) Filed: Aug. 16, 2017

(51) Int. Cl. G06Q 30/06

(52) U.S. Cl. CPC G06Q 30/0605; G06Q 30/0635

(57) ABSTRACT

A system and method for processing fractional share sales transactions wherein a user electronically interfaces with a computing device including software for collecting personal, contact and payment information from users, offering fractional shares of a lot for sale, creating fractional share purchase orders, collecting payment for the fractional share purchase orders and aggregating fractional share purchase orders to equal a whole lot. Once a complete or whole lot is so aggregated the system and method operate to purchase the lot comprising the fractional shares. Following purchase, the system and method distribute fractional shares of the lot to the fractional share purchasers. In one embodiment the system and method are configured to permit and facilitate users with trading or selling portions of their allocated or selected fractional share of the lot with other users of the system.

This application claims the benefit of U.S. Provisional Application No. 62/378,083, entitled System and Method for Facilitating a Fractional Share Purchase of an Asset, Goods or Services, filed Aug. 22, 2016.

### BACKGROUND

### Field of Invention

The present invention relates to computer software, computing devices and computing technology. In particular, the present invention relates to a system and method for identifying multiple parties each having a desire to purchase a fractional share of a common asset, goods or services and accommodating such a transaction.

### Background

Instances may occur wherein a goods or services provider offers for sale multiples of a singular good or service in a lot, often at a discounted or bulk rate. Even when such goods or services are not offered at a discounted or bulk rate a purchaser may be motivated to by such a lot because there exists a high demand for the good or service and the purchaser prefers to make certain that his or her need or demand is met by purchasing a lot of the offered goods or services.

Instances may occur wherein a purchaser is aware of an offer to sell multiples of a singular good or service in a lot and does not necessarily want to purchase the entire lot, but rather would be interested in purchasing a fractional share of the offered lot. When there are numbers of such similarly situated individuals there exists an opportunity for a seller of such lots of goods or services to expand their market by facilitating the purchase of fractional shares of a lot.

One such instance that illustrates the concept is the offer for sale of season tickets, particularly to sporting events, although the concept is equally applicable to theater events or the like. Season tickets to attend professional and collegiate sports events are almost without exception offered for sale to the public. In many instances a purchaser may only want to or may only have time to attend a portion of the games in a particular season. Oftentimes a season ticket holder finds themselves in the position of wasting tickets, giving tickets away or possibly selling the tickets on a second tier market.

Sellers of such lots of goods or services may be motivated to facilitate the purchase of fractional shares of a lot for a number of reasons. For instance, sellers may see an opportunity to sell an increased number of lots of their offered goods or services as their offering will appeal to a greater number of purchasers. In addition sellers may be motivated by the fact that they may increase the likelihood of controlling or participating in the second tier market for the sale of unused tickets. Additionally, sellers may be motivated by the fact that they are able to capture contact information for an increased number of purchasers for the purpose of future marketing efforts. Additionally, sellers may be motivated by the fact that in the case of season tickets, the owner of a season ticket may gain rights to participate in other future events for instance opportunities to meet team members, offers to purchase limited edition or availability merchandise and most notably tickets to post-season games, which may be severed from the package of rights or benefits that a purchaser of a full season ticket would enjoy. These rights could be offered by the seller in subsequent independent offers or lotteries.

An object of the present invention then is to provide a system and method for facilitating sales transactions of fractional shares of an asset, goods, services or lot, to a plurality of users.

### SUMMARY

The present invention then relates to computer software, computing devices and computing technology. In particular, the present invention relates to computing devices, computer software and computing technology for offering fractional shares of a common asset, goods or services to a plurality of users each having a desire to purchase a fractional share of the common asset, goods or services and facilitating the purchase and sale of such fractional shares. A system including a computing device having executable instructions or software, functions to interface and interact with a user's personal computing device. The system collects user personal and contact information, payment information and authorization of the user to purchase a selected or specified fractional share of an asset, goods or services. The system offers fractional shares of a common asset, goods, services or lot, to a plurality of users, obtains purchase orders for fractional shares from a plurality of purchasers, collects payment for the fractional share purchaser orders, “pools” the fractional share orders and aggregates fractional share orders to equal a complete lot comprising multiple fractional shares, purchases a lot, divides the lot into fractional shares and distributes the fractional shares.

Fractional share purchasers need not be affiliated by region, acquaintance or any other environmental factor. Rather, the computing device executable instructions operates to pool a plurality of fractional share purchase orders and aggregate the fractional share purchase orders into groups each equaling a complete lot. Once a complete lot is aggregated, purchase of the lot is executed. The system then divides and then distributes the fractional shares to the respective fractional share purchasers.

Factors or parameters that may be defined by the system include specified or selectable fractional shares of an asset, goods or services, specified or selectable price preference or value ranges that a user is willing to spend for a fractional share of the asset, goods or services and a payment method preference of the user.

In a preferred embodiment the system is configured to allow a user to purchase a fractional share of a season ticket for a sport team's season home games. In this embodiment, a user logs into the system remotely. In the event that a user is a first time user, the system will collect predetermined information from the user in order to create a user account. The system then offers the user a specified or selectable fractional share of a season ticket allotment. Similarly, in one embodiment, the system may be configured to offer a user to specify or select a price range per ticket. Similarly, in one embodiment, the system may be configured to offer a user to specify or select a preference as to a section of the stadium or venue. Once the user has made a selection of the fractional share that they are willing to purchase, a fractional share purchase order is created and payment for the fractional share is collected from the user through an electronic transfer of funds or credit card billing. The system pools the fractional share purchase order identified to the user with other fractional share purchase orders from a plurality of users. The system then aggregates fractional share purchase orders into a complete season ticket order, at which time the system executes the purchase of the season ticket and divides and distributes the individual tickets to the fractional share purchasers whose fractional share orders comprise the complete season ticket.

In one embodiment, the system allows any given user the option to rescind their purchase order within a specified time. If no users rescind within a specified time, the purchase is made and the individual tickets comprising the season ticket are distributed. In a preferred embodiment the system is configured to reserve all rights to promotional and secondary rights appurtenant to the purchase of a season ticket to the system owner for sale or distribution, for instance in a lottery for rights to purchase tickets for post-season play.

In one embodiment, the system and method pool only like fractional share purchase orders, for instance only those fractional share purchase orders by users wanting to buy a one-half fractional share are pooled together. Similarly, only those fractional share purchase orders by users wanting to buy a one-quarter fractional share are pooled together, and so on.

In various embodiments, the lot purchased by the group of fractional share purchasers may be divided among the purchasers in a variety of ways. The lot may be randomly distributed. Alternately the lot may be distributed in a pre-determined order established by the service provider. In another embodiment, the lot may be distributed in a “round robin” where purchasers are allowed to select a single unit from the lot in a rotating sequence. Alternately the round robin may be administered in such a manner that a purchaser has picks that occur in a manner that accounts for difference in the size of a particular fractional share. For example, a purchaser of a one-half fractional share and two purchasers each owning a one-quarter fractional share would select in such a manner that the one-half purchaser would select every other pick in the rotating sequential order while a one-quarter fractional share owner would select every fourth pick in the rotating sequential order.

In another embodiment the system is configured to permit and facilitate purchasers with trading or selling any single unit in their allocated or selected fractional share of the lot with other users of the system.

In one embodiment, a user accesses the system using a personal computing device, for instance a cell phone, and creates an account through the system website providing personal, contact and payment information. Once a user account has been created the user may log in to the system and select a sport for which they are interested in obtaining a fractional share of a season ticket. The system offers one or more teams from which the user may select. The system may then offer the user a variety of price ranges for various fractional shares representing seating selections, i.e. behind home plate, home team infield, outfield seats, upper tier or the like. Once any offered selections are made, a fractional share purchase order is created and payment is collected for the fractional share from the purchaser. The system aggregates fractional share purchases to equal one season ticket. At that time the system makes the purchase and the tickets are distributed to the fractional share purchasers. Tickets may be distributed in either paper or electronic format.

### BRIEF DESCRIPTION OF THE FIGURES

FIG. 1 is a schematic flow diagram showing a method for facilitating a fractional share purchase.

FIG. 2 is a schematic flow diagram showing a method for facilitating a fractional share purchase.

FIG. 3 is a schematic flow diagram showing a method for facilitating a fractional share purchase.

FIG. 4 is a schematic diagram showing a system for facilitating a fractional share purchase.

### DETAILED DESCRIPTION

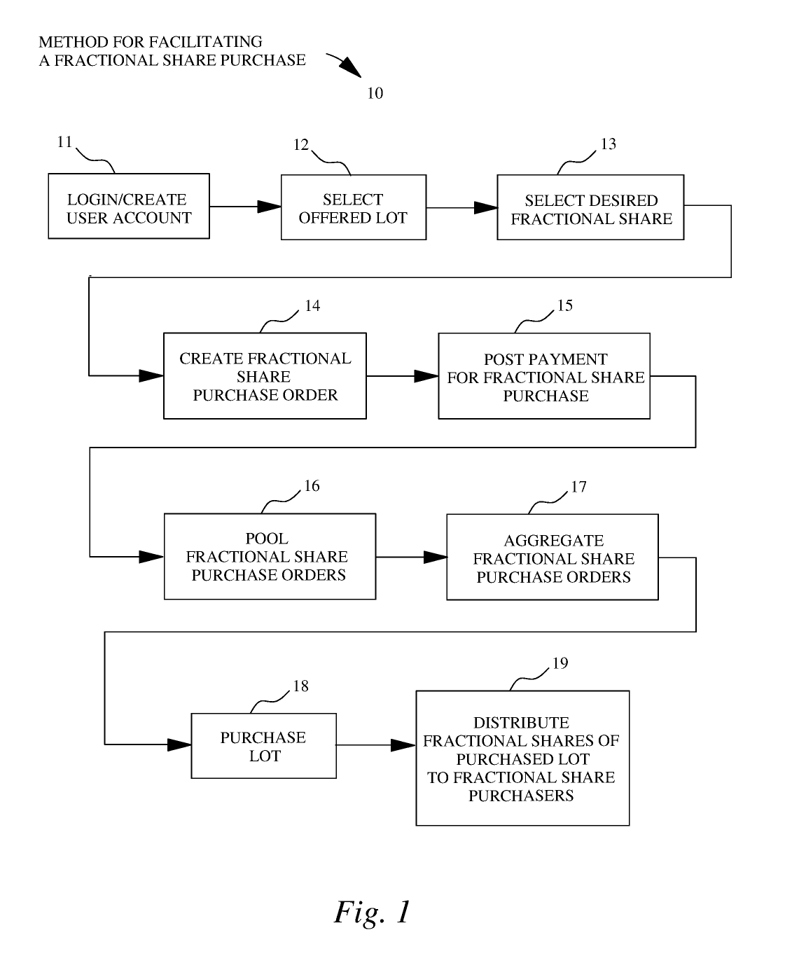

Referring to FIG. 1 METHOD FOR FACILITATING A FRACTIONAL SHARE PURCHASE 10 is shown including the steps of LOGIN/CREATE USER ACCOUNT 11 where a user accesses the system via a personal computing device having an internet browser or via a mobile device that includes a machine executable application for accessing the system via a wireless network and/or the internet. The user logs into the system identifying to the system as a previously registered user or in the event that the user has not previously registered with the system, they may follow the prompts to register as a new user. A new user will be prompted to create a username and password and may also be prompted to provide other personal information including address, phone number and payment or credit card information. Alternately the system and method of the present invention may wait until a fractional share purchase order is created by the user to prompt the user to provide required personal information including email address, mailing address, phone number and payment or credit card information.

Once the user has logged onto the system, the user may choose an offered lot at SELECT OFFERED LOT 12. As used herein the term and concept of a lot may include any item or asset service that may be purchased and divided into fractional shares, for instance, but in no way limited to, season tickets for sports teams or cultural events produced by theater and opera companies symphony orchestras or series events and the like. Once a desired lot is selected the user selects a desired fractional share that they would like to purchase at SELECT DESIRED FRACTIONAL SHARE 13.

Once the fractional share is selected the user creates a purchase order at CREATE FRACTIONAL SHARE PURCHASE ORDER 14. Once the system accepts the purchase order the user will be prompted to post payment for the desired fractional share together with any associated handling costs at POST PAYMENT FOR FRACTIONAL SHARE PURCHASE 15. In the preferred embodiment payment is posted to a credit card that has been placed on record with the system during the user registration process.

Once payment is posted the user's fractional share purchase order is pooled with other pending fractional share purchase orders at POOL FRACTIONAL SHARE PURCHASE ORDERS 16. At AGGREGATE FRACTIONAL SHARE PURCHASE ORDERS 17, the system and method operate to aggregate fractional purchase orders in such a manner that they are combined to equal a whole lot. For instance, two one-quarter fractional purchase orders may be aggregated with a one-half fractional share purchase order to form a whole lot. Similarly three one-third fractional share purchase orders may be aggregated to form a whole lot and so forth. Once fractional share purchase orders have been aggregated to form a whole lot, a lot is purchased at PURCHASE LOT 18. Following the purchase of the lot, the method and system distribute the fractional shares of purchased lot to fractional share purchasers according to the terms of the fractional share purchase orders at DISTRIBUTE FRACTIONAL SHARES OF PURCHASED LOT TO FRACTIONAL SHARE PURCHASERS 19.

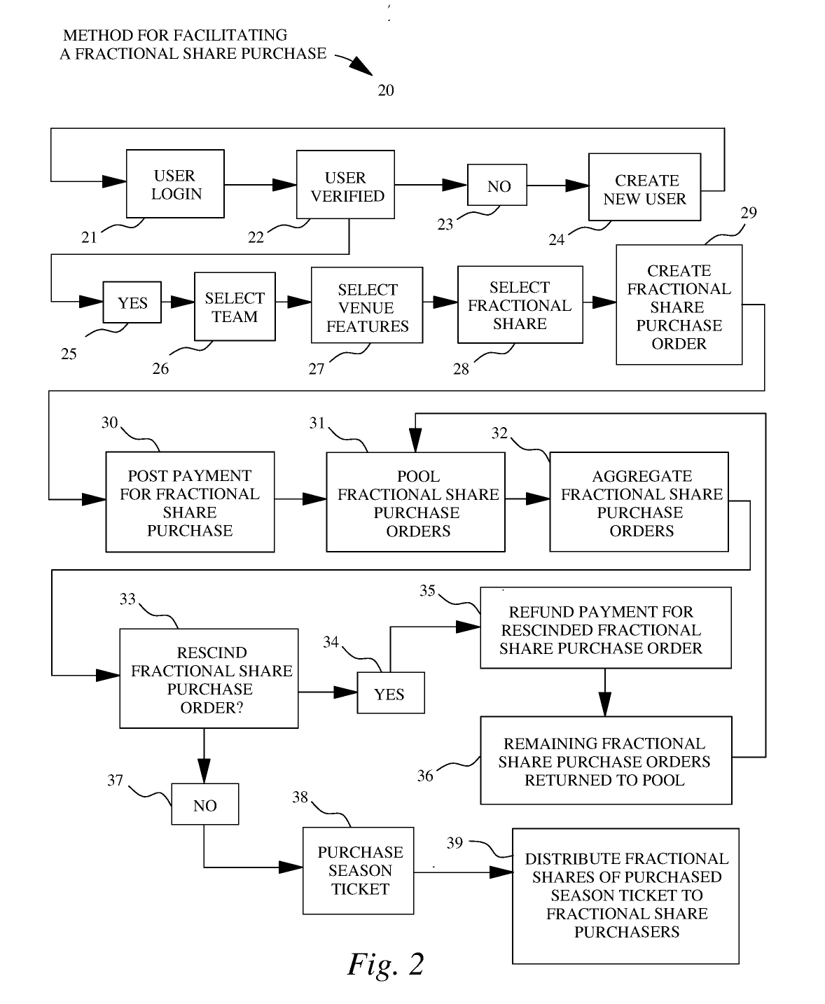

Referring to FIG. 2, a method for the sale of fractional shares of season tickets for sports teams and events is shown as METHOD FOR FACILITATING A FRACTIONAL SHARE PURCHASE 20 as the method may apply to the purchase of a fractional share of a season ticket for team sporting events. As used herein the term season ticket includes the right to seating in a specified seat or area of the stadium for the “home” games of a selected team as well as any appurtenant rights that may attach to the season ticket, for instance, any personal seat license that applies to the specified seat.

The method, as it applies to the sale of fractional shares of season tickets for sports teams and events includes the steps of USER LOGIN 21 wherein a user logs in entering their user name and password which are verified by the system. At USER VERIFIED 22 the method and system verifies the user identity. At NO 23, a would-be user or new user is prompted to create a new user at CREATE NEW USER 24. Once a new user is created the system and method return the user to USER LOGIN 21 where they will be prompted again to enter their user name and password at USER VERIFIED 22.

Once the system and method verify the user at YES 25, the user is prompted to select a team at SELECT TEAM 26. The user may select a team from a menu or a series of menus that display all sports teams that offer fractional share purchases through the system. For instance in one embodiment all teams regardless of the sport or league may be listed on one menu. Alternately, the user may select a sport from a first menu and a team from a second menu. At SELECT VENUE FEATURES 27 the user may be prompted to select other venue features such as preferred seat section. Once desired venue features are selected, the user selects a fractional share price or price range at SELECT FRACTIONAL SHARE 28. Once the desired selections have been made, the user will be prompted to create a fractional share purchase order at CREATE FRACTIONAL SHARE PURCHASE ORDER 29. After creating the fractional share purchase order, the user will be prompted to post payment at POST PAYMENT FOR FRACTIONAL SHARE PURCHASE 30.

Once payment is posted for the fractional share purchase order, the fractional share purchase order is pooled with all other pending fractional share purchase orders for the same team and for the same venue features at POOL FRACTIONAL SHARE PURCHASE ORDERS 31. According to the method of the present invention the concept of “pooling the fractional share purchase orders” include fractional purchase orders are filing data relating to fractional share purchase orders in a common database for subsequent aggregation or combination. Accordingly the system and methodology operate to aggregate or combine fractional share purchase orders in the pool to satisfy the purchase of a season ticket at AGGREGATE FRACTIONAL SHARE PURCHASE ORDERS 32.

Once fractional share purchase orders have been aggregated to satisfy the purchase of a season ticket, the system and method operate in this embodiment to offer the fractional share purchasers an opportunity to rescind their fractional share purchase order at RESCIND FRACTIONAL SHARE PURCHASE ORDER? 33. In the event that a user should decide to rescind at YES 34, the system and method operate to refund payment to the user at REFUND PAYMENT FOR RESCINDED FRACTIONAL SHARE PURCHASE 35 and return the remaining fractional share purchase orders to the pool at REMAINING FRACTIONAL SHARE PURCHASE ORDERS RETURNED TO POOL 36. Where all fractional share purchasers represented in an aggregated group of fractional share purchaser orders opt not to rescind at NO 37, the method and system operate to complete the purchase of a season ticket at PURCHASE SEASON TICKET 38. It is important to distinguish that in the preferred embodiment of the invention, it is system and the service that operates the system that purchases the season ticket and therefore is the owner of the season ticket and as such can reserve any rights to participate in other future events typically appurtenant to a season ticket, for instance, opportunities to meet team members, offers to purchase limited edition merchandise and most notably rights to participate in early or exclusive sale of tickets to post-season games.

At DISTRIBUTE FRACTIONAL SHARES OF PURCHASED SEASON TICKET TO FRACTIONAL SHARE PURCHASERS 39, the system and method operate to distribute the individual event tickets to the fractional share purchasers on a basis that is proportional to the fractional share represented by each of the fractional share purchase orders that have been aggregated to comprise the season ticket. Preferably this is done in a round robin fashion so that dates for the events covered by the season ticket are evenly distributed.

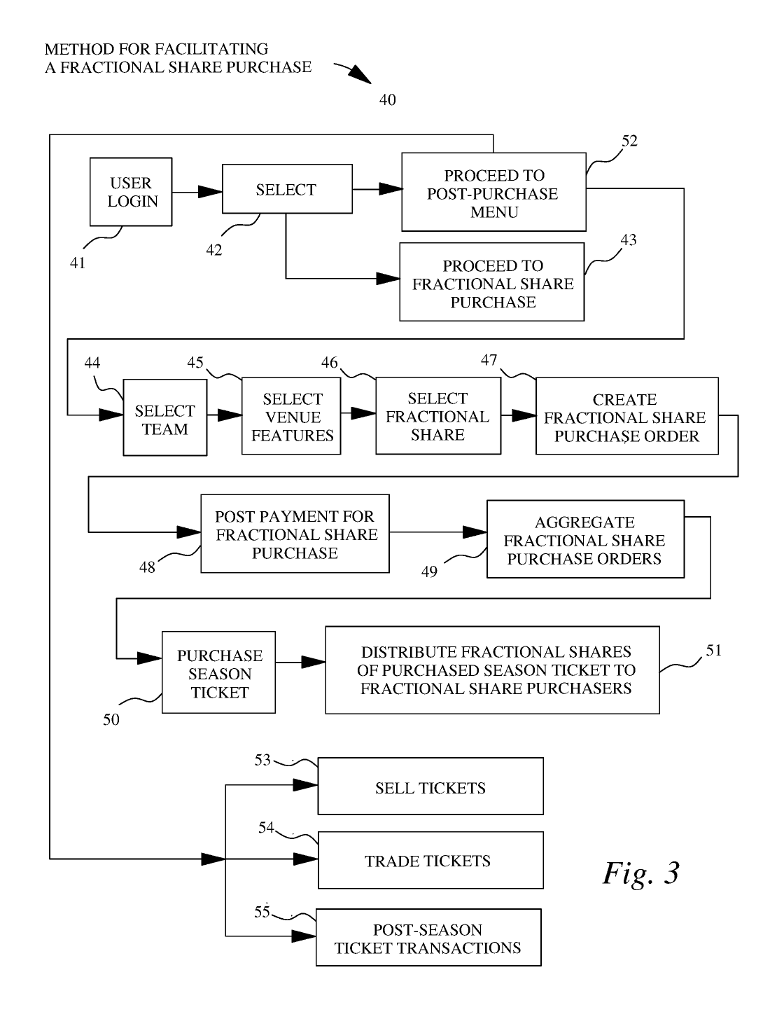

Referring to FIG. 3, METHOD FOR FACILITATING A FRACTIONAL SHARE PURCHASE 40, an alternate preferred embodiment of the method of the present invention is shown that includes post purchase options that may be made available to fractional share purchasers. FIG. 3 depicts a situation that assumes that the user has previously registered as a user, therefore at USER LOGIN 41, the user is presented with an option at SELECT 42 to proceed with a fractional share purchase at PROCEED TO FRACTIONAL SHARE PURCHASE 43, or alternately, and in the case where the user has previously completed a fractional share purchase and the fractional share has been distributed, the user is presented with an option to proceed to a post-purchase transaction selection at PROCEED TO POST-PURCHASE MENU 52.

In those cases where the user elects PROCEED TO FRACTIONAL SHARE PURCHASE 43, the method and system prompt the user to select a team at SELECT TEAM 44. This step may also include selections for a particular sport and/or league as previously discussed. At SELECT VENUE FEATURES 45 the user may be prompted to select other venue features such as preferred seat section. Once desired venue features are selected, the user selects a fractional share price or price range at SELECT FRACTIONAL SHARE 46. Once the desired selections have been made, the user will be prompted to create a fractional share purchase order at CREATE FRACTIONAL SHARE PURCHASE ORDER 47. After creating the fractional share purchase order, the user will be prompted to post payment at POST PAYMENT FOR FRACTIONAL SHARE PURCHASE 48.

According to this alternate embodiment method of the present invention the system and methodology next operate to aggregate or combine fractional share purchase orders as they are created to satisfy the purchase of a season ticket at AGGREGATE FRACTIONAL SHARE PURCHASE ORDERS 49. Accordingly the method and system operate an algorithm that operates to compare fractional share data and venue feature data of newly created fractional share purchase orders as payment for the same is posted in order to combine or aggregate the newly created fractional share purchase orders with other previously created and paid for fractional share purchase orders in order to satisfy the purchase of a season ticket. Once an aggregate of fractional share purchase orders satisfy the purchase of a season ticket, the method and system operate to complete the purchase of a season ticket at PURCHASE SEASON TICKET 50. At DISTRIBUTE FRACTIONAL SHARES OF PURCHASED SEASON TICKET TO FRACTIONAL SHARE PURCHASERS 51, the system and method operate to distribute the individual event tickets to the fractional share purchasers on a basis that is proportional to the fractional share represented by each of the fractional share purchase orders that have been aggregated to comprise the season ticket.

In the event that the user selects PROCEED TO POST-PURCHASE MENU 52 when prompted following user login, the user may be presented with options at SELL TICKETS 53, TRADE TICKETS 54 and/or POST-SEASON TICKET TRANSACTIONS 55. In some embodiments, registered users may have access to post-purchase ticket transactions including access to markets for selling or trading single or multiple tickets from their fractional share of the season ticket. In addition, registered users may have access to post-season ticket sales or lotteries for post-season ticket sales for playoff and championship play.

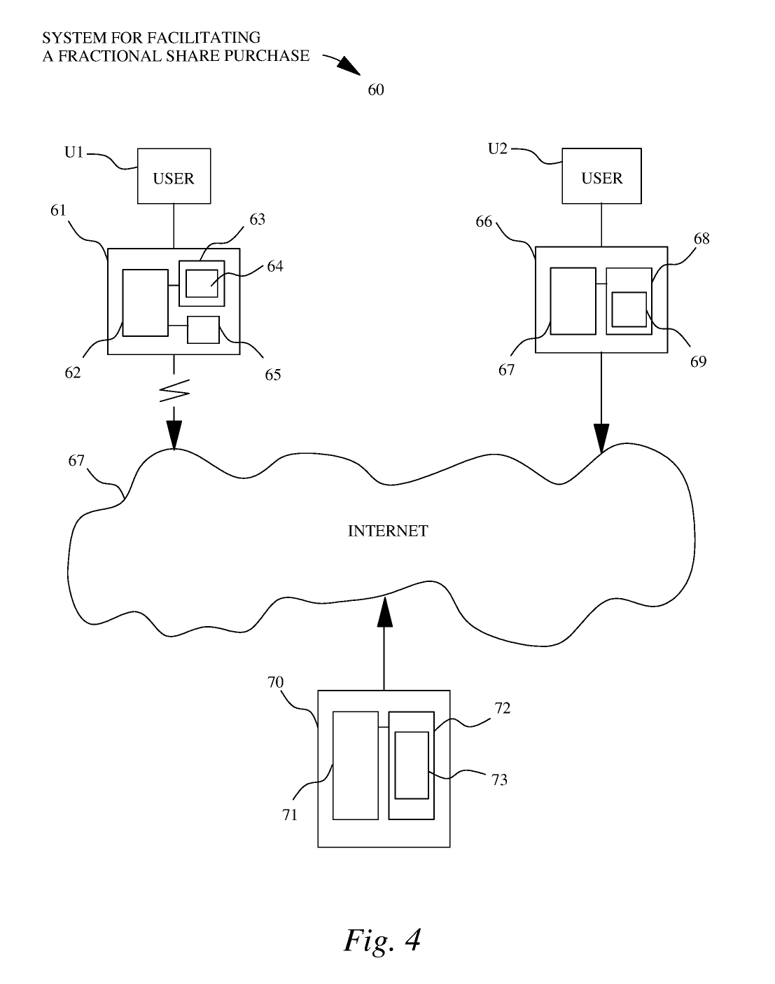

Referring to FIG. 4, SYSTEM FOR FACILITATING A FRACTIONAL SHARE PURCHASE 60 is shown wherein user U1 accesses server 70 configured for facilitating fractional share transactions via the internet 77. In a first instance user U1 accesses system by means of mobile device 61. Mobile device 61 includes processor 62 connected to memory 63. Machine executable application 64 is stored on memory 63 and is executable by processor 62 to interface with server 70 configured for facilitating fractional share transactions via the internet 75 through transceiver circuit 65.

Alternately user U2 accesses server 70 by means of personal computing device 66. Personal computing device 66 includes processor 67 connected to memory 68. Machine executable application 69 is stored on memory 68 and is executable by processor 67 to interface with server 70 configured for facilitating fractional share transactions via the internet 75.

Server 70 for facilitating fractional share transactions includes processor 71 connected to memory 72. Machine executable instructions 73 are stored on memory 72 and are executable by processor 71 to interface with user devices such as mobile device 61 and personal computing device 66 to facilitate fractional share transactions via the internet 75. Machine executable instructions 73 may include modules or means for managing interface with user devices, event selection, venue feature selection, payment and refund processing, fractional share distribution and post purchase transactions. Additionally, machine executable instructions 73 may include modules or means for tracking availability of season tickets or other assets, means for establishing connection with banking or financial services to process payment and refund transactions and means for creating and managing files relating to users and user transactions. Machine executable instructions 73 may also include modules or means for establishing secure connection to internet 75 and or means for communicating with users via email.

The foregoing description of the illustrated embodiments has been presented for purposes of illustration and description and is not intended to be exhaustive or to limit the invention to the precise form or to exemplary embodiment(s) and implementation(s) disclosed. Modifications and variations will be apparent to practitioners skilled in this art. Process steps described might be interchangeable with other steps in order to achieve the same result. At least one preferred embodiment was chosen and described in order to best explain the principles of the invention and a best mode of practical application, thereby to enable others skilled in the art to understand the invention and the various modifications that are suited to the particular use or implementation contemplated. The scope of the invention is defined by the claims appended hereto and their equivalents. Reference to an element in the singular is not intended to mean “one and only one” unless explicitly so stated, but rather means “one or more.” No claim element herein is to be construed under the provisions of 35 U.S.C. Sec. 112, sixth paragraph unless the element is expressly recited using the phrase “means for . . . ”

What is claimed is:

1. A method for facilitating fractional share purchase transactions wherein a user accesses a server for facilitating fractional share purchases via an internet connection by means of a user operated computing device, the system for facilitating fractional share purchases including a processing device, a memory device connected to the processing device, the memory device including device executable instructions for facilitating user registration and login, selecting a fractional share, creating a fractional share purchase order, processing payment for fractional share purchase orders aggregating fractional share purchase orders, purchasing a lot comprising aggregated fractional share purchase orders and distribution of fractional shares to fractional share purchasers on a basis that is proportional to a fractional share represented by each of the fractional share purchase orders that have been aggregated to comprise a purchased lot, the method for facilitating fractional share purchase transactions including the steps of:
logging onto the system for facilitating fractional share purchase via the internet using a user operated computing device;
selecting an offered lot;
selecting a fractional share of the lot;
creating a fractional share purchase order including a total owed for a selected fractional share of the lot plus any related transaction fees;
posting payment for the fractional share purchase order;
aggregating fractional share purchase orders placed by a plurality of users to satisfy a purchase of a whole lot;
purchasing the whole lot; and
distributing fractional shares of a purchased lot to the plurality users on a basis that is proportional to the fractional share represented by each of the fractional share purchase orders that have been aggregated to comprise the whole lot.

2. The method for facilitating a fractional share purchase transactions of claim 1 wherein the step of posting payment for the fractional share purchase order always occurs before the step of purchasing the whole lot.

3. A method for facilitating a fractional share purchase of a season ticket wherein a user accesses a system for facilitating fractional share purchases via an internet connection by means of a user operated computing device, the system for facilitating fractional share purchases including a processing device, a memory device connected to the processing device, the memory device including device executable instructions for facilitating user registration and login, selecting a fractional share, creating a fractional share purchase order, processing payment for fractional share purchase orders aggregating fractional share purchase orders, purchasing a lot comprising aggregated fractional share purchase orders and distribution of fractional shares to fractional share purchasers on a basis that is proportional to a fractional share represented by each of the fractional share purchase orders that have been aggregated to comprise a purchased lot, the method for facilitating fractional share purchase transactions including the steps of:
logging onto the system for facilitating fractional share purchases via the internet using a user operated computing device;
selecting an offered season ticket for a selected team;
selecting a fractional share of the season ticket;
creating a fractional share purchase order including a total owed for a selected fractional share of the season ticket plus any related transaction fees;
posting payment for the fractional share purchase order;
aggregating fractional share purchase orders placed by a plurality of users to satisfy a purchase of a whole season ticket;
purchasing the whole season ticket; and
distributing fractional shares of a purchased season ticket to the plurality users on a basis that is proportional to the fractional share represented by each of the fractional share purchase orders that have been aggregated to comprise the whole season ticket.

4. The method for facilitating a fractional share purchase of a season ticket of claim 3 wherein the step of posting payment for the fractional share purchase order always occurs before the step of purchasing the whole lot.

5. The method for facilitating a fractional share purchase of a season ticket of claim 3 further including the step of selecting a team.

6. The method for facilitating a fractional share purchase of a season ticket of claim 3 further including the step of selecting venue features.

7. The method for facilitating a fractional share purchase of a season ticket of claim 3 further including the step of pooling paid for fractional share purchase orders prior to aggregation of fractional share purchase orders.

8. The method for facilitating a fractional share purchase of a season ticket of claim 3 further including the step of offering the user an option to rescind the fractional share purchase order prior to execution of purchase of the whole season ticket.

9. The method for facilitating a fractional share purchase of a season ticket of claim 3 further including the step of offering the user an option to select a post-purchase service selected from a group of post-purchase services including sale of individual tickets, trade of individual tickets and participation in post-season transactions.

10. A system for processing fractional share purchase transactions, the system including:
a user operable computing device including a processor, storage device connected to the processor, the user operable computing device configured to access devices via an internet connection;
a server for facilitating fractional share purchases including a processing device, means for accessing other user operable computing device via the internet connection, a memory device connected to the processing device, the memory device including device executable instructions configured to;
permit a connected user to register with the system;
permit a registered user to login;
permit a registered user to select of a fractional share;
create a fractional share purchase order;
process payment for the fractional share purchase order;
aggregate fractional share purchase orders;
purchase of a lot comprising aggregated fractional share purchase orders; and
distribute fractional shares to fractional share purchasers on a basis that is proportional to a fractional share represented by each of the fractional share purchase orders that have been aggregated to comprise a purchased lot.

11. The system for facilitating a fractional share purchase of a season ticket of claim 10 wherein the device executable instructions further comprise executable instructions configured to permit a registered user to select a team.

12. The system for facilitating a fractional share purchase of a season ticket of claim 10 wherein the device executable instructions further comprise executable instructions configured to permit a registered user to select venue features.

13. The system for facilitating a fractional share purchase of a season ticket of claim 10 wherein the device executable instructions further comprise executable instructions configured to pool paid for fractional share purchase orders prior to aggregation of fractional share purchase orders.

14. The system for facilitating a fractional share purchase of a season ticket of claim 10 wherein the device executable instructions further comprise executable instructions configured to permit a registered user to rescind a fractional share purchase order.

15. The system for facilitating a fractional share purchase of a season ticket of claim 10 wherein the device executable instructions further comprise executable instructions configured to permit a registered user to select a post-purchase service selected from a group of post-purchase services including sale of individual tickets, trade of individual tickets and participation in post-season transactions.
